(19) United States
(12) Patent Application Publication
(10) Pub. No.: US 2025/0185674 A1
(43) Pub. Date: Jun. 12, 2025

(54) HEALTHY FLOUR-FREE BAKERY PRODUCT BASED ON AVOCADO AND METHOD FOR MANUFACTURING THE SAME

(71) Applicant: SIN REMORDIMIENTO S.A.S., MEDELLÍN (CO)

(72) Inventor: Maria Antonia DUQUE HENAO, Medellin, Antioquia (CO)

(21) Appl. No.: 18/846,040

(22) PCT Filed: Mar. 7, 2023
(86) PCT No.: PCT/IB2023/052161

§ 371 Date: Sep. 11, 2024

(30) Foreign Application Priority Data
Mar. 15, 2022 (CO) NC2022/0003017

(51) Int. Cl. A21D 13/068; A21D 2/16; A21D 2/26; A21D 2/36; A23G 1/30

(52) U.S. Cl. CPC A21D 13/068; A21D 2/165; A21D 2/262; A21D 2/36; A23G 1/30

(57) ABSTRACT

A bakery product, such as a cake, brownie, cookie, or any other similar product is provided, which is based on natural products and which lacks flour, wherein the product is characterized by being healthy and the fats are natural, such as avocado to give a pleasant texture and flavor, without the use of products with saturated fats that can be harmful to the consumer's health. A method for manufacturing the aforementioned bakery product is also provided, wherein the method allows obtaining a product with an adequate texture and where highly important and relevant variables are involved that are necessary to achieve a healthy product.

### CROSS-REFERENCE TO RELATED APPLICATIONS

This application is a national stage of PCT Application No. PCT/IB2023/052161, having a filing date of Mar. 7, 2023, which is based on CO Application No. NC2022/0003017, having a filing date of Mar. 15, 2022, the entire contents both of which are hereby incorporated by reference.

### FIELD OF TECHNOLOGY

The following relates to the technical field of bakery products, more specifically those that are considered healthy because they do not contain components that can affect human health.

Thus, the following is related to a bakery product, such as a cake, brownie, cookie, or any other similar product, which is based on the use of natural products and which lacks flour, where the product is characterized in that it is healthy and the fats are natural, such as avocado to give a pleasant texture and flavor, without the use of products with saturated fats that can be harmful to the consumer's health. Likewise, the following defines a method for manufacturing the aforementioned bakery product, wherein the method allows obtaining a product with an adequate texture and where highly important and relevant variables are involved that are necessary to achieve a healthy product.

### BACKGROUND

Bakery products are widely known in the market and have existed for many years, which makes them one of the most consumed products worldwide. Usually, these products are based on wheat flour, which is combined with other ingredients that allow a specific density, texture and flavor to be obtained, which are very pleasant for the consumer.

However, in recent years it has been discovered that these products, although they have a desired and pleasant flavor, can be harmful to health, while they can affect people who do not tolerate some ingredients, especially gluten, which is present in wheat flour, whereby the search for alternatives that lead to baked products, maintaining the traditional flavors and textures, which are sought by consumers, has become a constant need.

In this sense, currently multiple options for bakery products based on non-traditional ingredients, that is, using different types of flours, fats, etc., can be found, thus replacing the traditional ingredients that may be harmful to health.

Thus, in the state of the conventional art there is a plurality of disclosures related to products that can be considered healthy, where replacement ingredients are used, among which is document DE 4302881 teaching a spreadable cream comprising vegetable fat, which predominantly contains a portion that is a butter consisting of the pulp of avocado fruit, sweetening agents such as sugar in a content from 10 to 30%, and cocoa powder in a content from 5 to 15%. In addition, the spread defined herein may contain coffee powder, ginger, lemon juice, vanilla syrup or vanilla sugar, conventional food additives, such as E202, E211 or E205, stabilizers (E410 or E412) and antioxidants (E300). Preferably, avocados are of the Hass type. Thus, the spread contains lower levels of carbohydrates, higher levels of unsaturated fatty acids and lower levels of calories than products conventionally found on the market.

However, the invention disclosed in the document has the inconvenience or disadvantage that it is not precisely related to a baked product, but rather corresponds to a spreadable cream, which has a manufacturing process very different from that of a bakery product, while it does not require oven cooking.

On the other hand, document CN 106616335 relates to a nutritional breakfast and its preparation method within food processing, where the nutritional breakfast is prepared from the following components with their proportions: 100 to 200 parts of black rice, 50 to 100 parts glutinous rice, 50 to 100 parts black beans, 50 to 100 parts dark chocolate, 50 to 100 parts nutritional aids, 10 to 20 parts avocado, 5 to 10 parts pollen, 1 to 5 parts of black olive oil, 1 to 5 parts of dried shrimp, and 300 to 500 parts of water. Thus, all these components are mixed and combined in a series of steps to obtain the adequate nutritional breakfast that has a series of healthy and suitable properties for the human body.

However, this document does not specifically define a baked product, but rather refers to a nutritional breakfast that has a series of components that are mixed to be ingested by the user, where emphasis is placed on the use of various grains that increase the amount of carbohydrates and cannot be considered a healthy product to be baked.

There is also document CN 106993652 which teaches a spongy bakery product based on avocado and its manufacturing method, wherein the spongy bakery product comprises cake flour, butter, milk, eggs, avocado, white sugar, salt, cream, and honey. Thus, the avocado-based bakery product is a natural and simple source, whose nutritional components are fused, thus improving its nutritional value. In addition, the bakery product has a very pleasant taste sensation and is unique in taste.

However, the product defined in this document has the disadvantage and inconvenience that it is manufactured from wheat flour, as well as the use of white sugar and butter, which are ingredients considered unhealthy and that can affect the health of the consumer. Moreover, the product is considered to have a traditional flavor, that is, it does not present additional flavors such as chocolate or similar that may be pleasant or desired by the consumer.

Similarly, document CN 109892371 discloses a mooncake based on avocado, which includes an external or covered part and a filling. The outer part or covering is prepared from flour, vegetable oil, eggs, white wine and yeast, while the mooncake filling is prepared from sesame oil, avocado, raisins, almonds, honey and milk. Thus, an avocado has a very high fiber content, therefore, soluble fibers can remove excess cholesterol from a body, and insoluble fibers help maintain the normal functions of a digestive system to prevent constipation. This product belongs to natural healthy foods without chemical additives, and can be consumed by people who are allergic to common ingredients.

However, the food product defined in this document has the disadvantage that the product has a crust or cover and a filling, where avocado is used for the filling and does not contain chocolate, which would make it necessary to use another type of fats and flours that may be undesirable or would not correspond to what can be considered a healthy product.

Finally, document RU 2756531 relates to the baking and sweets industry, and it discloses a method for the production of a muffin (commonly known as a “cupcake”) comprising a mixture and sugar that are shaken for 5 to 7 minutes until the sugar grains dissolve, then syrup and sunflower oil is added, continue mixing for 2 to 3 minutes, then add salt, baking soda, dry milk, mashed avocado and mix for 2 to 3 minutes until a homogeneous dough is obtained, then the resulting dough is kneaded with wheat flour for 1 to 2 minutes. Thus, the dough is placed in molds treated with a special coating and baked at a temperature from 180 to 200° C. for 25 to 50 minutes, depending on the weight. After baking, the muffins are cooled for 2 to 3 hours, removed from the molds and packaged for distribution.

However, although this document specifically discloses a bakery product (muffin or “cupcake”) that is baked and has mashed avocado among its ingredients, it is based on wheat flour, that is, it contains gluten and, therefore, cannot be considered within the category of healthy foods.

From the above information, it is clear that the existing documents in the state of the conventional art correspond to a plurality of food products, some bakery products, that have a series of ingredients that allow obtaining a product suitable for human consumption, where in all cases, avocado is used as a source of natural oil for the formation of the food product. Likewise, in some cases components that give chocolate flavor are used, and in some others there are chemical additives which are not suitable for human health.

Thus, it can be seen that the food products disclosed in the conventional art all have the inconvenience and disadvantage that they use different ingredients that are not considered healthy, such as wheat flour, butter (saturated fat), sugar, etc., and although they may include healthy fats, such as avocado, this can be used to obtain a filling or in the form of oil, but which does not replace the sources of fats that are commonly used in this type of products.

Furthermore, it should be considered that the documents in the state of the conventional art that define this type of bakery products always use some type of flour as a basis to manufacture the product, usually wheat flour, which is undesirable.

According to the above information, it is clear for those skilled in the conventional art that there is a need to obtain a baked product, which can be classified as healthy according to its ingredients, where it is highly desirable that it does not contain any type of flour or processed sugars, while replacing saturated fats with fats of natural origin that have a beneficial effect on human health, while requiring the product to have a pleasant taste and a texture that is suitable and very similar to products manufactured with conventional techniques and ingredients.

Considering the aforementioned problems and/or needs, proposed herein is a new bakery product, which is baked, such as a cake, brownie, cookie, or any other similar product, wherein the product is based mainly on natural products and which lacks flour, where the product is characterized because it is healthy, and the fats are natural.

In an embodiment, the bakery product of the present invention has as its base ingredients an oil of healthy vegetable origin, for example coconut oil, which is mixed with high percentage cocoa, for example in powder form. To sweeten the product, it is necessary to add a sweetening agent that is not processed, for example Stevia, which is obtained from the plant that bears its name.

Of the traditional ingredients of bakery products, the product of embodiments of the present invention contain baking powder and egg, which are ingredients that must be present to obtain the desired final texture and consistency, but that do not affect the final product nor its category of “healthy.”

Finally, the bakery product is mixed with a source of healthy fat, for example avocado, which is mixed with the other ingredients to obtain a highly healthy product, without flour and with excellent properties for human health.

Similarly, in an embodiment, the bakery product can be coated with a high percentage cocoa-based coating, for example with cocoa greater than 50%, in order to have a chocolate coating that is highly palatable.

In an embodiment, the product is solid or may contain a filler, which may be for example a sauce or other liquid or viscous ingredient or product that is injected therein. In an embodiment, the filling is a candy or caramel made from some healthy, non-dairy product, such as, but not limited to, almond caramel.

Likewise, embodiments of the present invention define a method for manufacturing the aforementioned bakery product, wherein the method comprises the steps of melting the chocolate by any commonly known means, such as in a microwave oven or in a water bath, together with the natural fat source, for example coconut oil. Then, once the chocolate has been melted, cocoa powder is added and mixed until a homogeneous mixture is obtained.

Subsequently, the natural sweetener is hydrated, such as Stevia, where in embodiments it may be desired that the amount of water used for the hydration be very little or as minimal as possible.

Simultaneously, the avocado is taken and processed until obtaining a creamy and homogeneous consistency, and then the hydrated Stevia is added, mixed and eggs are added, one by one, until finished depending on the amount of product to be made.

Then, mixing the chocolate mixture obtained previously with the avocado mixture until a homogeneous texture is obtained, constantly reviewing the walls of the bowl and the bottom of the bowl with a spatula, wherein the mixing process is carried out.

The egg whites are then whipped vigorously until a consistency similar to shaving foam is obtained, commonly known as snow point. Then, the egg whites are incorporated into the previously obtained mixture, making enveloping movements.

Finally, the resulting mixture is baked in a mold with the desired shape for the time necessary to cook the interior of the product. Then, the mold is removed, allowed to cool and portions of the desired size are obtained and then packaged or served for direct consumption.

### BRIEF DESCRIPTION

Some of the embodiments will be described in detail, with references to the following Figures, wherein like designations denote like members, wherein:

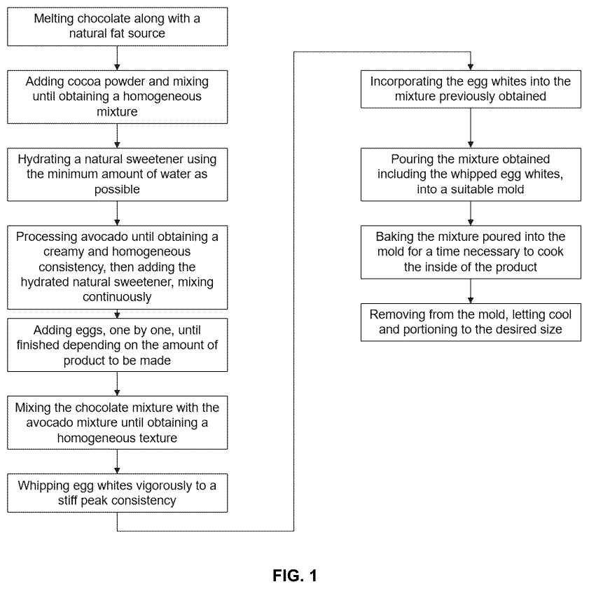

FIG. 1 corresponds to a flow chart of the manufacturing method of embodiments the present baked product.

### DETAILED DESCRIPTION

Embodiments of the present invention are directed to a new bakery product, which is baked, such as a cake, brownie, cookie, or any other similar product, wherein the product is based mainly on natural products and which lacks flour, wherein the product is characterized by being healthy and having natural fats.

Likewise, FIG. 1 shows a flow chart of the method for manufacturing or obtaining the bakery product according to embodiments of the present invention. The bakery product comprises, essentially comprises, or consists, generally, without limitation, of the following parts or components:
A naturally occurring oil ingredient, such as coconut, but not limited thereto, wherein the naturally occurring oil ingredient is present in an amount from 2.5 to 3.5% by weight;
Chocolate with a cocoa content greater than 50%, which may be for example melted and whipped, wherein the chocolate is present in an amount from 25 to 30% by weight;
Cocoa powder, which is present in an amount from 2.5 to 3.5% by weight;
A sweetening agent of natural origin without chemical components, which for example may correspond to Stevia, wherein the sweetening agent of natural origin is present in an amount from 3.2 to 4.2% by weight;
A leavening agent that allows the bakery product to rise, such as, but not limited to, baking powder, wherein the leavening agent is present in an amount from 0.8 to 1.5% by weight;

Whole eggs, that is, including both yolk and white, which are present in an amount from 25 to 33% by weight;
Egg whites present in an amount from 8 to 13% by weight; and
A fatty component of natural origin, such as avocado, for example pureed, which is present in an amount from 30 to 40% by weight.

Thus, the bakery product of embodiments of the present invention may be for example a brownie, although it is not limited to this type of product and, in general, it can be any type of baked product that has the desired texture and flavor, such as a cake, cookie, bread, etc.

In an embodiment, the bakery product of the present invention may be coated with a coating with pleasant flavor and, which may be but is not limited to, of the same color or the same nature of the essence of the bakery product, such as chocolate.

Thus, the bakery product of embodiments of the invention can be covered with a cocoa coating with a proportion greater than 50% (pure cocoa content), which is poured over the product when it has already been prepared and cooled and divided into the desired portions.

In addition to the above, in other alternative embodiments, the bakery product of the present invention, whether coated or uncoated, may contain a filling that is also made of a sweet and pleasant ingredients, for example but not limited to, where the filling may correspond to caramel that is obtained from a vegetable source, that is, for example non-dairy, such as, without limitations, almond caramel, hazelnut-based cream, red fruit jam, coconut cream, blueberry cream with coconut milk, avocado cream with white chocolate based on coconut milk, among others, not limited only to the above.

In an embodiment, the filling may be present in the bakery product in a content in the range from 25 to 35% by weight, without being limited thereto.

Embodiments of the present invention are also directed to a method for manufacturing or obtaining a bakery product, as defined above, wherein the method comprises the steps of:
a) melting chocolate containing at least 50% cocoa content by any commonly known means, together with a natural fat source;
b) once the chocolate has been melted and is mixed with the natural fat source, adding cocoa powder and mixing until obtaining a homogeneous mixture;
c) hydrating a natural sweetener, such as Stevia, where in embodiments it may be desirable that the amount of water used for the hydration be very little or as minimal as possible;
d) processing avocado until obtaining a creamy and homogeneous consistency, and then adding the hydrated natural sweetener, mixing continuously;
e) adding eggs, one by one, until finished depending on the amount of product to be made;
f) mixing the chocolate mixture previously obtained with the avocado mixture until obtaining a homogeneous texture in a bowl, constantly cleaning the walls of the bowl and the bottom with a spatula;
g) whipping egg whites vigorously until obtaining a stiff peak consistency;
h) incorporating the egg whites into the mixture previously obtained in step f), making enveloping movements;
i) pouring the mixture obtained in the previous step, including the stiff egg whites, into a suitable mold;
j) baking the mixture poured into the mold for the time necessary to cook the interior of the product; and
k) removing from the mold, letting cool and portioning to the desired size.

In this sense, for example, the step of melting chocolate with at least 50% cocoa content is carried out in a microwave oven or in a water bath.

In an embodiment, the natural fat source used in the chocolate melting step may be, but is not limited to, coconut oil.

The previous description defines embodiments of the invention and lists a plurality of steps that allow obtaining a result for the method to be protected. However, those skilled in the conventional art clearly understand and know that the steps defined above are not limited to a specific order, but can be carried out in any order, depending on their application, wherein the order of steps is intended to be covered by this document and contemplates performing the steps of the method in any desired order.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A healthy bakery product comprising:
oil of natural origin;
chocolate with a cocoa content greater than or equal to 50%;
cocoa powder;
sweetening agent of natural origin without chemical components;
leavening agent for fluffing the bakery product;
whole eggs, that is, including both yolk and white;
egg whites; and
a fatty component of natural origin, such as avocado.

2. The healthy bakery product according to claim 1, wherein the amounts of the components of the product are:
from 2.5 to 3.5% by weight of oil of natural origin;
from 25 to 30% by weight of chocolate with the cocoa content greater than 50%;
2. 5 to 3.5% by weight of cocoa powder;
from 3.2 to 4.2% by weight of sweetening agent of natural origin;
from 0.8 to 1.5% by weight of leavening agent;
25 to 33% by weight of whole eggs;
8 to 13% by weight of egg whites; and
30 to 40% by weight of fatty component of natural origin, such as avocado.

3. The healthy bakery product according to claim 1, wherein the oil of natural origin is coconut oil.

4. The healthy bakery product according to claim 1, wherein the sweetening agent of natural origin is Stevia.

5. The healthy bakery product according to claim 1, wherein the leavening agent is baking powder.

6. The healthy bakery product according to claim 1, further comprising a chocolate coating.

7. The healthy bakery product according to claim 1, further comprising a filling being caramel obtained from a vegetable source.

8. The healthy bakery product according to claim 1, wherein the bakery product is a cake, brownie, cookie, or similar product.

9. A method for manufacturing or obtaining a bakery product, comprising:
a) melting chocolate that contains at least 50% cocoa content, along with a natural fat source;
b) once the chocolate has been melted and mixed with the natural fat source, adding cocoa powder and mixing until obtaining a homogeneous mixture;
c) hydrating a natural sweetener
d) processing avocado until obtaining a creamy and homogeneous consistency, and then adding the hydrated natural sweetener, mixing continuously;
e) adding eggs, one by one;
f) mixing the chocolate mixture with the avocado mixture until obtaining a homogeneous texture;
g) whipping egg whites vigorously to a stiff peak consistency;
h) incorporating the egg whites into the mixture previously obtained in f);
i) pouring the mixture obtained in the previous step, including the stiff egg whites, into a mold;
j) baking the mixture poured in the mold for a time necessary to cook the inside of the product; and
k) removing from the mold, letting cool, and portioning to the desired size.

10. The method according to claim 9, wherein the chocolate to be melted has 50% or more cocoa content, and the natural fat source is coconut oil.

11. The method according to claim 9, wherein hydrating the natural sweetener is performed with a minimum amount of water possible.

12. The method according to claim 9, wherein incorporating the egg whites into the mixture previously obtained in f) is performed by making circular movements.
